(19) United States
(12) Patent Application Publication
(10) Pub. No.: US 2002/0151420 A1
(43) Pub. Date: Oct. 17, 2002

(54) Worktable Apparatus

(76) Inventors: William B. Scott, Rochelle, IL (US); Michael P. Dixon, Rockford, IL (US); Joachim H. Mayer, Belvidere, IL (US)

Correspondence Address: Donald J. Ersler, 725 Garvens Avenue, Brookfield, WI, 53005, US

(21) Appl. No.: 09/961,029

(22) Filed: Sep. 21, 2001

Related U.S. Application Data
(60) Provisional application No. 60/283,312, filed on Apr. 12, 2001.

(51) Int. Cl. B23Q 3/155; B23D 7/08; B23H 1/00

(52) U.S. Cl. 483/29; 83/953; 219/68; 409/219; 266/65; 219/121.39; 219/121.58

(57) ABSTRACT

A worktable apparatus for a machine tool, such as a CNC punch press, a laser equipped machine tool or plasma torch equipped machine tool, which processes a metal sheet or plate workpiece. The worktable apparatus serves a dual function as (a) a worktable that supports a workpiece during processing by a machine tool and as (b) an unloading station for unloading a workpiece or a skeletal remnant produced by the machine tool. The machine tool has a set of workclamps, which move under CNC control along at least one of the numerically controlled axes, grip the workpiece and carry it through the machine for processing. Located on one side of the machine tool, the worktable apparatus has a surface adapted to allow the workpiece to ride smoothly under the motive power of the workclamps. In one embodiment, the worktable apparatus is made up of two roller sets supported such that one long edge of each is fixed to a frame, and the other edge is normally supported in horizontal orientation creating a gap between the roller sets. When a workpiece or a skeletal remnant is rolled into position on the worktable apparatus and the CNC initiates the worktable apparatus to open, controlled actuators, such as cylinders, cause the center edges of the two roller sets to drop away, allowing the workpiece or skeletal remnant to fall freely from its supported position on the worktable apparatus to an unloaded position below.

### CROSS-REFERENCE TO RELATED PATENT APPLICATIONS

This patent application claims the benefit of U. S. provisional patent application No. 60/283,312 , filed Apr. 12, 2001.

### FIELD OF THE INVENTION

The present invention relates generally to machine tools, and more particularly to a worktable apparatus that serves a dual function as (a) a worktable that supports a workpiece during processing by a machine tool and as (b) an unloading station for unloading a workpiece or skeletal remnant produced by the machine tool.

### BACKGROUND OF THE INVENTION

There is a continuing effort within the metal fabrication industry to automate and improve CNC punch presses to reduce manufacturing cost, improve productivity, and to reduce the setup time and general workload of the operator of the machine. CNC punch presses have been developed with automatic loading and unloading systems. Some CNC punch presses are equipped with a plasma torch or a laser cutting attachment. Such machines process nests of parts. The plasma torch or laser cutting attachment is used to cut large holes that exceed the maximum punch size available or exceed the punching capacity of the press and to cut the outer boundary of parts. Some embodiments of plasma cutting machines and laser cutting machines, not having a punching apparatus, also process nested parts.

A nest is a group of parts of a common material type and thickness, grouped in a common sheet or plate. Processing parts in this manner makes it possible to use a common sheet size for production, reduces setup time, and reduces scrap. Software for nesting parts and creating part programs of nests for controlling laser equipped or plasma torch equipped CNC punch presses has been commercially available for several years.

Processing nested parts on a CNC punch press having a plasma torch or a laser cutting attachment typically produces a skeletal remnant that is scrap material. Various means have been employed to automatically remove the remnant from the CNC punch press. All means that the inventors are aware of have employed a transfer apparatus to grip the remnant in some manner and pull it off the machine or transfer it to a separate device for stacking on a pallet or on the floor. Several embodiments of such apparatus employ a dedicated transfer mechanism that pulls the remnant from the machine tool worktable. Another form employs a robotic loading/unloading device to grip the skeletal remnant with dedicated clamps that swing into position from a load platen and transfer it to a separate scrap table for stacking. While such devices have been functional, they have inherent disadvantages.

The cost of a dedicated transfer mechanism is a disadvantage. A dedicated transfer mechanism takes up valuable floor space. In some cases there is limited floor space available. A separated scrap table for stacking remnants also requires floor space. There can be “lost time” associated with transferring the remnant. Skeletal remnants by nature are inherently weak and can be difficult to handle.

### BRIEF SUMMARY OF THE INVENTION

It is an objective of the invention to quickly remove skeletal remnants from a CNC machine tool and to minimize the cost of equipment to do so.

It is another objective to minimize dedicated floor space for stacking skeletal remnants at the machine tool.

It is a further objective to remove a skeletal remnant from a CNC machine tool worktable without employment of a dedicated transfer mechanism.

It is another objective of the invention to provide a worktable that supports a workpiece during processing thereof by a machine tool and that stacks the remaining skeletal remnant thereof proximate to the floor.

It is a further objective of the invention to provide a worktable that can be adapted with different workpiece supporting means that supports a workpiece during processing thereof by a machine tool and that can quickly unload the remaining skeletal remnant thereof.

It is yet a further objective of the of the invention to provide a worktable that can reside on the machine loading side of a machine tool, can support a workpiece during the loading function, can support the workpiece during processing of the workpiece by the machine tool, and can quickly unload the remaining skeletal remnant thereof from the machine tool.

Finally, it is another objective of the invention to provide a worktable that can reside on the side opposite of the machine loading side of a machine tool, that can support a workpiece during processing of the workpiece by the machine tool, and can quickly unload the remaining skeletal remnant thereof from the machine tool.

Other features and advantages of the invention will be readily apparent from the following description of a preferred embodiment thereof, taken in conjunction with the accompanying drawings, although variation and modifications may be effected without departing from the scope and spirit of the novel concepts of the invention.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a plan view of a CNC punch press employing a preferred embodiment of the invention.

FIG. 2 is a cross sectional view, generally taken through 2-2 of FIG. 1, and showing open workclamps, a remnant on the worktable and the worktable in a workpiece supporting position.

FIG. 3 is the view of FIG. 2 except the worktable is shown in a remnant unloading position with a remnant shown falling to a stack of remnants.

FIG. 4 is a front elevation view of the worktable of FIG. 1.

FIG. 5 is an end view, taken generally from 5-5 of FIG. 1, showing an alternate embodiment of the invention in which remnants can be removed through the end of the worktable.

FIG. 6 is a plan view of a CNC punch press having an alternate embodiment of the invention.

FIG. 7 is cross sectional view of a barrel roller than can be adapted to the worktable.

FIG. 8 is a plan view of an omni-wheel that can be adapted to the worktable.

FIG. 9 is a plan view of a CNC punch adapted with a preferred embodiment of the invention and adapted with a workpiece loader that is also capable of unloading large parts.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENTS

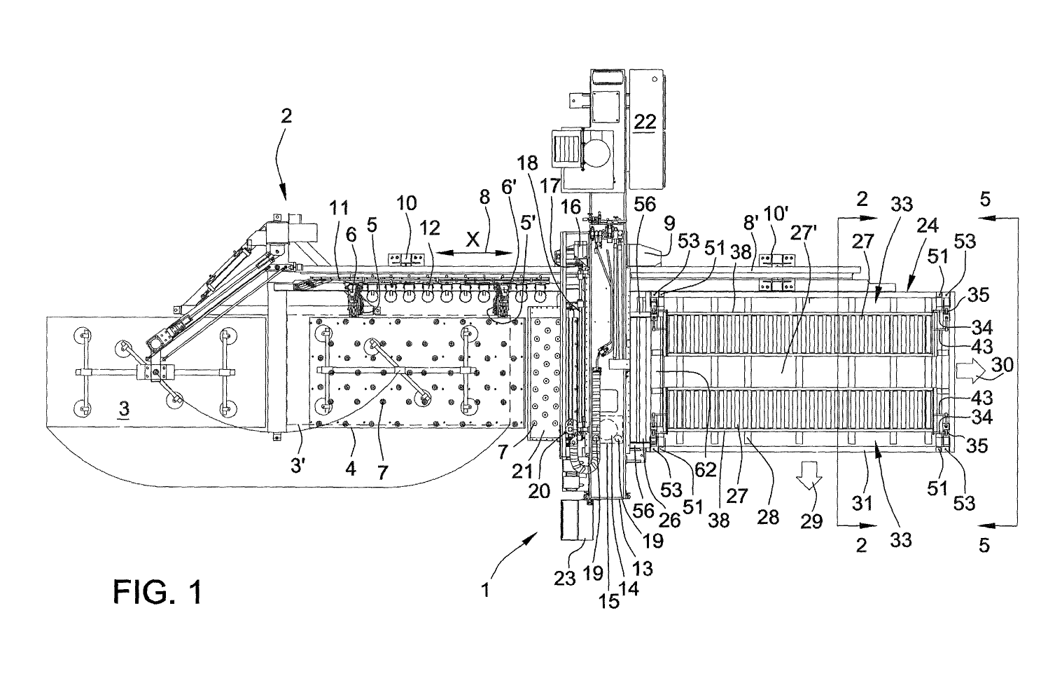

FIG. 1 is a plan view of a CNC punch press illustrating a preferred embodiment of the invention. FIG. 1 shows a machine tool 1, a CNC punch press having a loading apparatus 2. A stack of material 3 is staged proximate to the loading apparatus 2. The stack of material 3 is preferably flat, rectangular metal sheets and/or plates. The loading apparatus 2 is adapted to lift a single sheet 3′ from the stack of material 3. The single sheet 3′ is transferred over a worktable 4, lowered to the surface of worktable 4 then moved against registration surfaces 5 and 5′ of workclamps 6 and 6′. The worktable 4 is adapted with a plurality of ball transfers 7 such that the single sheet 3′ can be rolled on the worktable 4 by the loading apparatus 2 to load the sheet into the workclamps 6 and 6′. The loaded single sheet 3′ is called a workpiece.

Alternate embodiments of the machine tool 1 can be a CNC punching machine without a thermal cutting attachment or can be a thermal cutting machine such as a plasma torch or a laser not having a punching tool. The reference to the machine tool 1 is intended to apply inclusively to such machines unless the context clearly indicates otherwise.

In the preferred embodiment of the invention, movement of the workpiece is in only one direction, along the X-axis. Movement of the workhead effects movement in the Y-axis. There are many machine configurations in which the workclamps move in both the X and Y directions and the workhead remains stationary. Some configurations have stationary worktables adapted with spring loaded ball transfer bearings or brushes and an X-axis carrying rail translatable in the Y-axis to move the workpiece over the stationary worktables. The workclamps are mounted on a small table translatable in the X-axis that is carried on the translatable X-axis carrying rail. The invention is fully applicable to such machines. As will be apparent to one skilled in the art, after reading the following disclosure, the workclamps can be brought to a Y coordinate associated with “unload” then indexed in the X direction to carry the skeleton remnant over the drop leaf table before releasing it.

Alternate embodiments of machine tool 1 can be adapted with the thermal cutting attachment on the side opposite that shown or with the loading apparatus on the side opposite that shown. The invention is intended to apply inclusively to such embodiments unless the context clearly indicates otherwise.

The worktable apparatus is also adaptable to CNC punching machine configurations that are not adapted with an automatic loader. In such form, the worktable apparatus provides an inexpensive means to quickly remove a skeletal remnant from the machine tool. In rare instances the part produced by such a machine tool constitutes the entire workpiece 3′. In such instances the worktable apparatus can be utilized to unload and stack the part.

CNC punch press 1 has an X-axis 8 defined by a X rail 8′, supported by a bracket 9 and pedestals 10 and 10′, and carrying a translatable table 11. The translatable table 11 is driven by a servomotor and a ballscrew that are not shown and carries workclamps 6 and 6′, for gripping the workpiece 3′, and a plurality of punching tool sets 12. A press frame 13 carrying a translatable workhead 14 that is adapted for punching and is mounted to a mounting plate 15 defines the Y-axis. A translatable die support, not shown, is located below mounting plate 15. The workhead 14 is positioned along the Y-axis by a servomotor 16 connected by a coupling 17 to a ballscrew 18.

Proximate in front of the workhead 14 are two reposition cylinders 19 mounted on the bottom surface of the mounting plate 15. The function of the reposition cylinders 19 is to clamp the workpiece 3′ processed by machine tool 1 during workclamp reposition cycles. The workpiece is clamped by reposition cylinders 19 such that it will not move when workclamps 6 and 6′ are opened and repositioned relative to the workpiece 3′.

Connected to the left side the mounting plate 15 is a plasma torch 20 for cutting large holes and the outer boundary of parts from workpiece 3′. Below and to the immediate left of torch 20 is a drop leaf table apparatus 21 for removal of small parts after they have been cut from workpiece 3′. The drop leaf table apparatus 21 is adapted with ball transfers 7 for supporting workpiece 3′ as it is processed.

An electrical cabinet 22 houses the CNC and electrical controls and a operator station 23 provides the man/machine interface for machine tool 1.

During operation of machine tool 1, the workpiece 3′ is gripped by the workclamps 6 and 6′ and moved and positioned under CNC control along the X-axis 8 while the workhead 14 and the die support are moved and positioned under CNC control along the Y-axis. The workpiece 3′ is positioned and tools are selected according to a part program processed by the CNC. At commanded positions the CNC cycles the workhead 14 to punch a hole in the workpiece 3′. After all holes have been punched, the CNC in like manner positions the plasma torch 20 to commanded positions, lowers the plasma torch 20 to the workpiece 3′, ignites the plasma torch 20 then coordinates the velocity and motion of the X and Y axes to move the plasma torch 20 along a described path to create a hole or to cut a part from workpiece 3′. Small parts cut from the workpiece 3′ are unloaded via the drop leaf table 21. Large parts are removed manually or with the assist of a hoist or crane. When all parts have been removed from the workpiece 3′, the CNC via the workclamps 6 and 6′, positions the skeletal remnant on a worktable 24 to be unloaded.

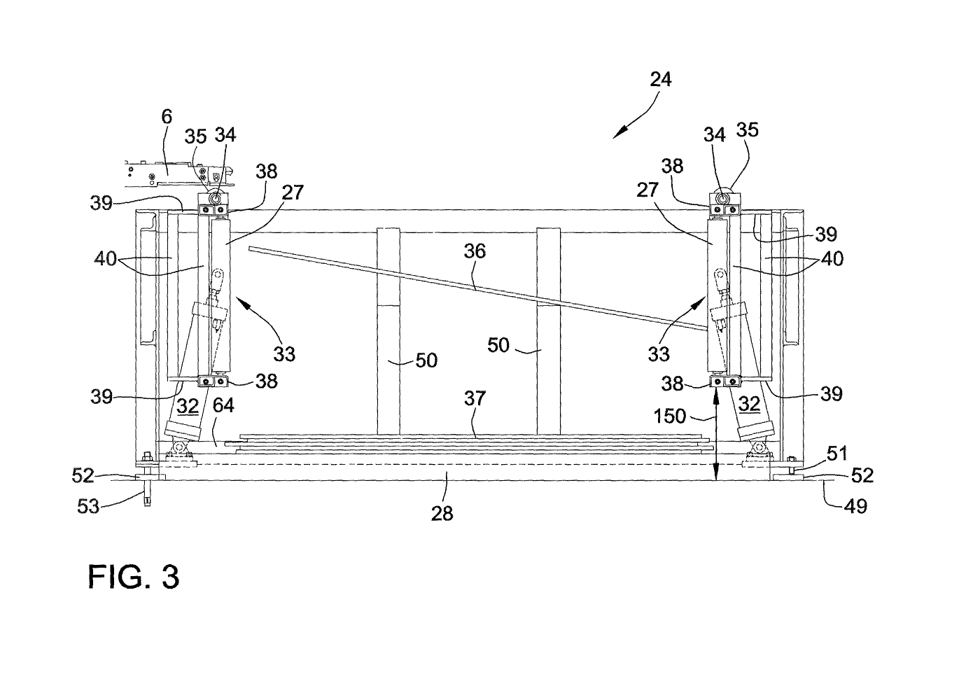

The worktable 24, on the right side of the frame 13, is adapted with two sets of conveyor rollers 27 forming two drop leaf tables 33 which support the workpiece 3′ while it is processed by the CNC punch press 1. The conveyor rollers are a workpiece supporting means. The roller sets 27 are separated by a gap large enough that the roller sets 27 may be controllably dropped (opened) to create a large opening through which a skeletal remnant can fall. FIG. 1 shows a relatively wide gap 27′ almost as wide as the roller sets 27. This arrangement provides adequate support for the workpiece 3′ and a space 150, FIG. 3, adequate for stacking remnants without causing interference with motion of the drop leaf tables 33. Other gap configurations may be used as long as the roller sets are capable of adequately supporting the workpiece 3′ and of moving between the closed workpiece supporting position and the open unloading position without interference.

The worktable 24, also called a worktable apparatus, a scrap table or a scrap table apparatus, is shown in a preferred form and is adapted to unload skeletal remnants 36 from machine tool 1 such that they fall through the scrap table 24 and are stacked on blocks 28 resting on or proximate the floor. Scrap table 24 can be adapted such that a stack of unloaded skeletal remnants 37 can be removed through the front side, shown by arrow 29 or through the end, shown by arrow 30. Scrap table 24 is adaptable to other CNC punching machine configurations. In such adaptations, the scrap table 24 can be configured such that unloaded remnants are removed from below the scrap table 24 through any side or end of the scrap table 24 that is not obstructed by the machine tool 1 or an associated apparatus.

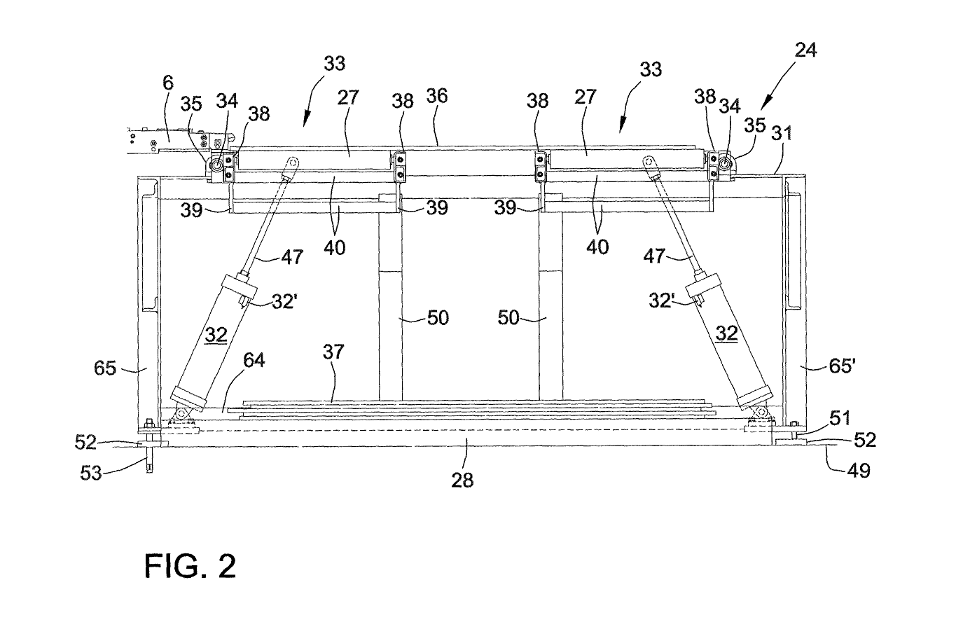

The worktable 24 has a frame 31 carrying cylinders 32 adapted to pivot drop leaf tables 33 via pivot shafts 34 about bearings 35 between positions horizontal, FIG. 2, such that drop leaf tables can support a workpiece 3′ or a skeletal remnant 36 and vertical, FIG. 3, such that the skeletal remnant 36 is dropped through the worktable 24 to stack 37 on blocks 28 resting on the floor. In a preferred form, drop leaf tables 33 are adapted as roller conveyors having side rails 38 supporting conveyor rollers 27. The cylinders 32 can be air, hydraulic, electric cylinders having a motor driven ballscrew apparatus, or any other suitable driving apparatus.

FIG. 2 is a sectional view, taken generally through 2-2 of FIG. 1, except that the workclamps 6 and 6′ are translated along the X-rail 8′ to carry the workpiece 3′ or the skeletal remnant 36 over the drop leaf tables 33. FIG. 2 shows an open workclamp 6′, a skeletal remnant 36 on the drop leaf tables 33 and the cylinders 32 in closed position. Elements common with FIG. 1 are labeled with same numbers as in FIG. 1. As best seen in FIG. 2, the side rails 38 are stiffened by a bar 39. The side rails 38 and the bars 39 of each conveyor are connected by cross ties 40.

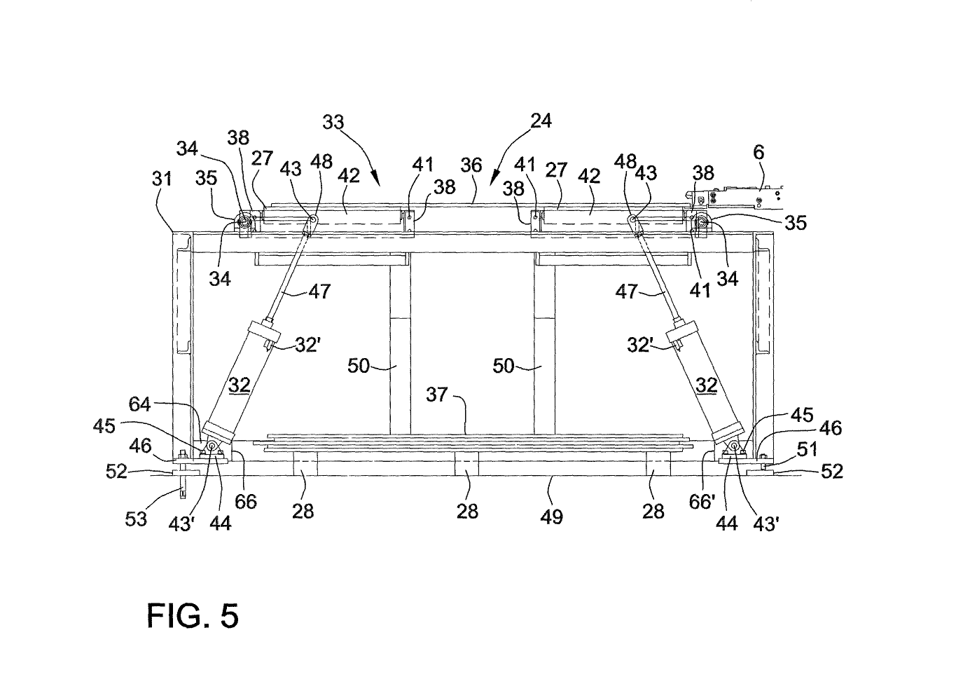

As best seen in FIG. 5, the side rails 38 are attached with screws 41 to a pivot bracket 42. Pivot shafts 34 and pins 43 are attached to the pivot brackets 42. The cap ends of cylinders 32 are clevis mounted by pins 43′ to clevis brackets 44, which are attached by screws 45 to plates 46 welded to the frame 31. Cylinder rods 47 are attached to rod eyes 48 pivotally connected to pins 43. Switches 32′ mounted on cylinders 32, FIG. 2, detect the position of the cylinder piston when cylinder rods 47 are extended providing indication that drop leaf table 33 is in closed horizontal position.

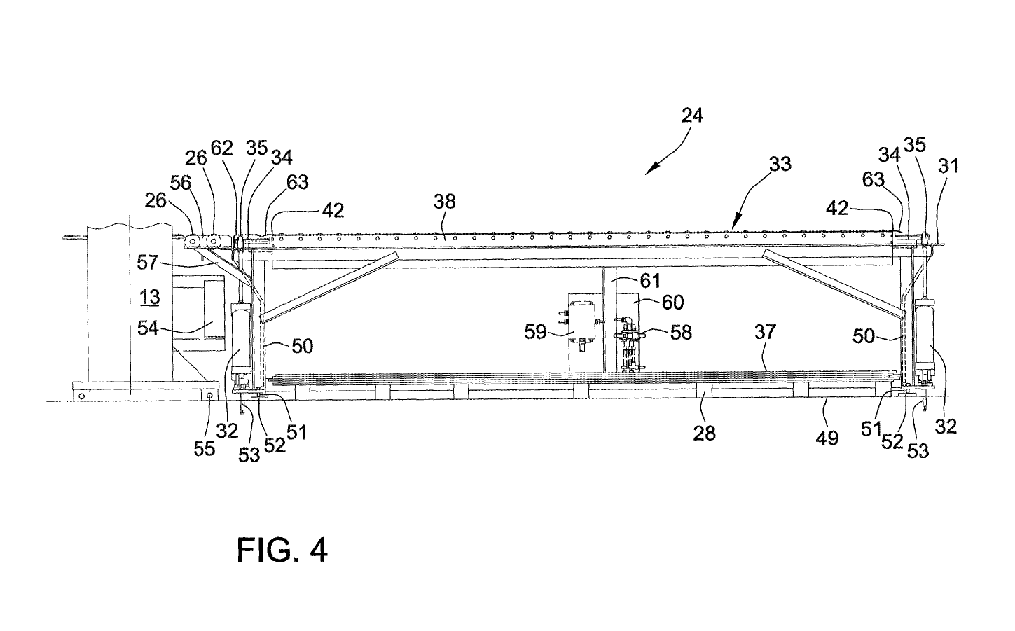

As best seen in FIGS. 2 and 5, when all parts have been removed from the workpiece 3′, the CNC via the workclamps 6 and 6′, positions the skeletal remnant 36 on worktable 24 to be unloaded. The CNC commands workclamps 6 and 6′ to open. As best seen in FIG. 3, the CNC commands cylinders 32 to retract causing drop leaf tables 33 to pivot from a closed horizontal position to an open vertical position causing skeletal remnant 36 to pull forward, free of workclamps 6 and 6′, and fall through scrap table 24 to the stack 37 resting on the blocks 28 laying on the floor 49. Best seen in FIG. 4 are the formed bars 50 at each end of the frame 31 which guide the skeletal remnant 36 as it falls to the stack 37.

The frame 31 fabricated primarily from steel angles, is supported proximate four corners by leveling screws 51 on pads 52 and bolted to floor 49 by anchor bolts 53.

FIG. 4 is a front elevation view of the worktable 24 of FIG. 1. A cable carrier 54 attached lower right side of the press frame 13 and a press frame leveling jack 55 restrict how close the worktable 24 can be mounted relative to the frame 13. A cantilevered frame 56, supported by a brace 57 holds two conveyor rollers 26 and comprises an extension to the worktable 24, for supporting a workpiece, such that the worktable 24 can be mounted clear of obstructions. A valve 58 and a cabinet 59 are mounted on a plate 60 supported by a vertical frame member 61. The valve 58 controls the cylinders 32 in response to signals from the CNC of machine tool 1. The cabinet 59 provides means to electrically connect the valve 58 and the switches 32′ to the CNC.

A guard 62, FIG. 4, resides between the cantilevered frame 56 and the drop leaf tables 33 to guide the end of a workpiece 3′ over the connection of the rod eye 48 to the pin 43. A deflector 63, proximate the left end of the scrap table 24 is attached to the pivot bracket 42 to guide the workpiece 3′ over pivot bracket 42. The deflector 63, proximate the right end of the scrap table 24, is attached to the pivot bracket 42 to guide the skeletal remnant 36 over the pivot bracket 42 in the event that the right end of the skeletal remnant 36 is inadvertently positioned beyond the pivot bracket 42.

In FIGS. 1-4 it is intended that the skeletal remnants stacked on blocks 28 be removed from worktable 24 through the front side, shown by arrow 29. Referring to FIG. 4, it is noted that the front side of frame 31 is open proximate the floor 49. Blocks 28 are arrayed parallel to the skeletal remnant removal direction 29. The skeletal remnant may also be referred to as unloaded material. The unloaded material could be a finished part or a skeletal remnant which would be the scrap portion of a workpiece 3′. The blocks 28 space the stack 37 above the floor 49 for insertion of lift truck forks to remove the stack 37.

Referring to FIGS. 2 & 3, it is noted that a horizontal frame member 64 is welded between legs 65 and 65′. FIG. 5 is an end view, taken generally from 5-5 of FIG. 1, of an alternate form of the invention such that remnants can be removed through the end of the worktable 24, as shown by reference arrow 30, FIG. 1. It is noted in FIG. 5 that the horizontal frame member 64 is cut away between 66 and 66′ for removal of the remnant stack 37. It is also noted that blocks 28 are arrayed parallel to the removal direction 30.

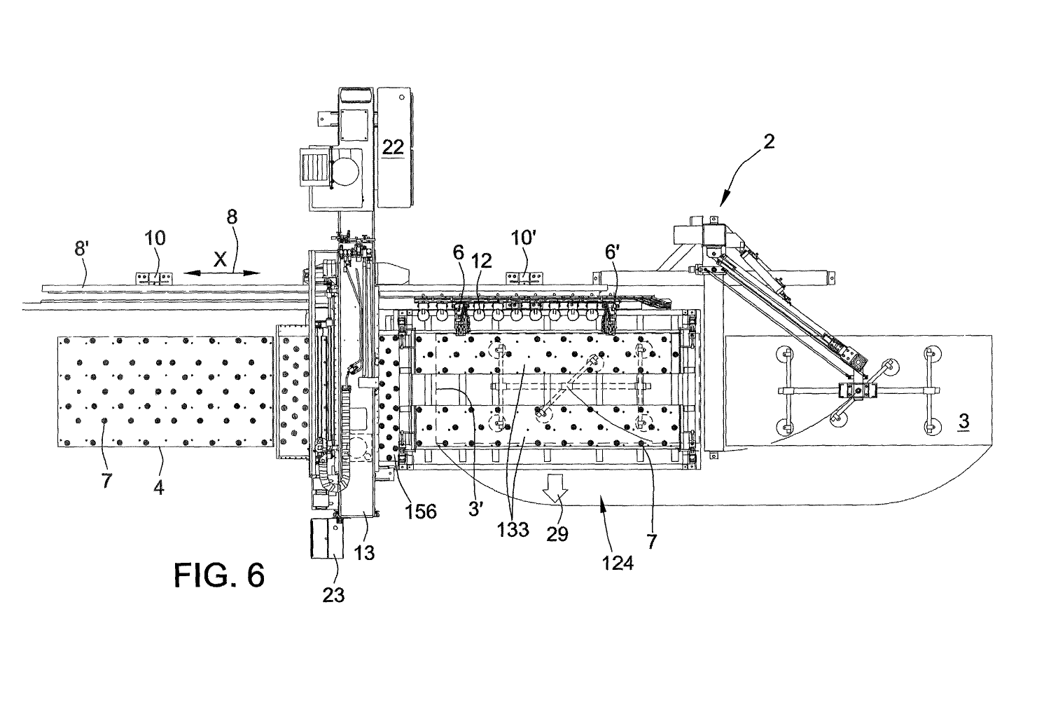

FIG. 6 is a plan view of a CNC punch press illustrating an alternate embodiment of the invention. Elements common with FIG. 1 are labeled with the same numbers as in FIG. 1. To avoid redundancy and for clarity, several elements common with FIG. 1 are not numbered. The loading apparatus 2 is located on the right side of the press frame 13 proximate the right end of a worktable 124 and loads a workpiece 3′ onto the worktable 124 and into the workclamps 6 and 6′. Drop leaf tables 133 and a cantilevered frame 156, FIG. 6, are adapted with the ball transfer bearings 7 as a workpiece supporting means in lieu of conveyor rollers. The workpiece 3′ can be rolled on the worktable 124 by the loading apparatus 2 to load the workpiece 3′ into the workclamps 6 and 6′. Skeletal remnants 37 are removed from the worktable 124 through the front side as indicated by the arrow 29.

In a further alternate form, the drop leaf tables 133 and cantilevered extension 156 can be adapted with skate wheel conveyors as a workpiece supporting means.

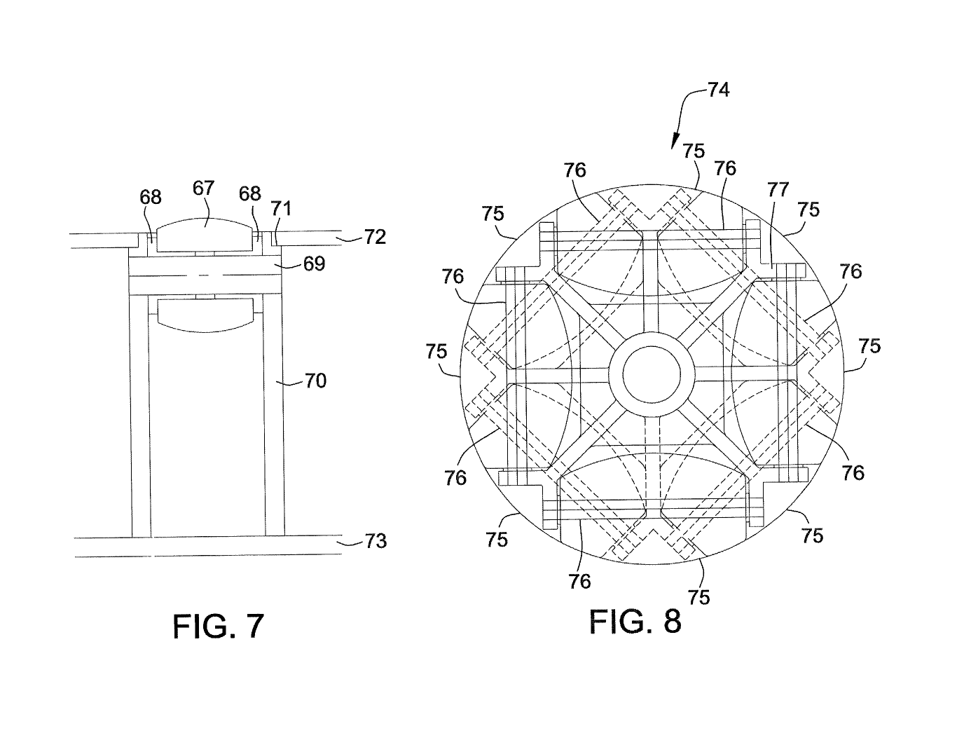

In another alternate form, the drop leaf tables 133 and the cantilevered extension 156 can be adapted with barrel rollers 67 as a workpiece supporting means. FIG. 7 is a sectional drawing of a single barrel roller 67 that can be adapted to the worktable 124. The barrel roller 67 is supported by flanged bearings 68 on a shaft 69 within a housing 70. The upper end of the housing 70 has a shoulder 71 for supporting sheet 72, the upper surface of the drop leaf table 133 or cantilevered frame 156. Housing 70 is sandwiched between sheet 72 and bottom plate 73 which are held together by fasteners not shown.

In another alternate form, the drop leaf tables 133 and the cantilevered extension 156 can be adapted with omni-wheels 74 for a workpiece supporting means. FIG. 8 is a drawing of a single omni-wheel 74 that can be adapted to the scrap table 124 in place of the ball transfer bearings 7. The omni-wheel 74 is adapted with eight barrel shaped rollers 75 supported by axles 76, four on the near side of a frame 77 and four on the back side of the frame 77 indexed 45 degrees relative to the four barrel rollers 75 on the front side. The omni-wheels 74 can be mounted in a manner similar to that shown in FIG. 7.

In another alternate form, the drop leaf tables 133 and the cantilevered extension 156 can be adapted with brushes in place of the ball transfer bearings 7. Brushes are adapted such that the brush tuft is turned upward to support the workpiece being processed. Brush type material support is used to prevent scratching of the workpiece during processing.

In alternate form, the worktables 24, 124 can be adapted with a pallet proximate the floor such that skeletal remnants are dropped through the worktable 24 or 124 to stack on a pallet. The pallet and stacked skeletal remnants are removable through a side or end of worktable 24, 124 for disposal of the skeletal remnants. In another alternate form, the worktable 24, 124 can be adapted with a conveyor proximate the floor, in place of blocks 28, such that skeletal remnants are dropped through worktable 24, 124 to a conveyor that transports the skeletal remnants elsewhere for storage or disposal.

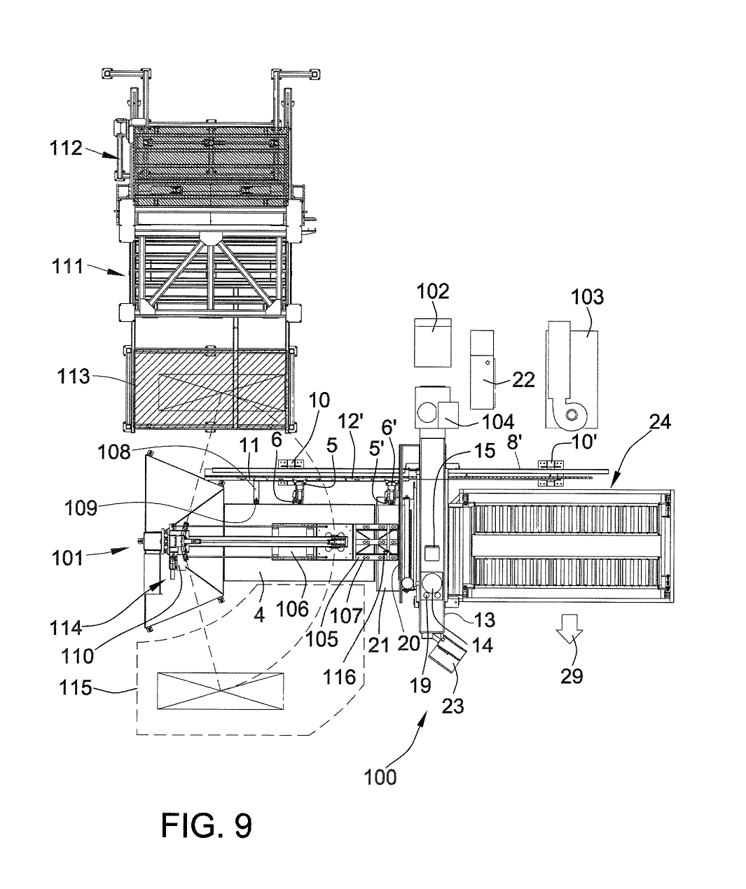

FIG. 9 is a plan view of a machine tool 100 embodied with a preferred loader/unloader 101. The loader/unloader 101 is described in a co-pending patent application of Michael A. Tomlinson, Sidney B. Schaaf, and Alfred J. Julian, application Ser. No. 09/______, descending from U.S. provisional patent application serial No. 60/283,300, filed Apr. 12, 2001, the teachings and disclosure of which are hereby incorporated in their entirety by reference thereto. Machine tool 100, a CNC controlled punch press, is like machine tool 1 of FIG. 1 except that the punching tool sets 12 of FIG. 1 are not shown. Several items equivalent to those of FIG. 1 are identified with same numbers. Some items equivalent to those of FIG. 1 are not identified to eliminate excessive redundancy.

Machine tool 100 is adapted to have punching tool sets distributed along a translatable X-axis table 11 held by holders 12′, also called pockets, in predetermined positions that are numbered, from left to right, 1 thru the total number of pockets on table 11. Number tags that are too small to be seen in FIG. 9 identify the pocket positions. The pockets 12′ can hold either a workclamp or a punching tool set. A workclamp can be moved to a pocket previously occupied by a punching tool set and a punching tool set can be moved to a pocket previously occupied by a workclamp.

Upon machine power up or after a change in machine setup the machine operator must run a machine setup program before the machine is used to produce parts. The setup program moves the X-axis table 11 carrying the workclamps 6 and 6′ and punching tool sets 12 such that the workclamps 6 and 6′ pass over a sensor that detects the pocket position numbers that hold a workclamp. The workclamp positions are stored for future use. Safety zones are then established for each workclamp to prevent collision of a workclamp with the workhead 15 or the plasma torch 20.

Proximate in front of the workhead 14 are two reposition cylinders 19 mounted on the bottom surface of mounting plate 15. When the workclamps 6 and 6′ must be repositioned relative to the workpiece in process, cylinders 19 clamp the workpiece such that it will not move when the workclamps 6 and 6′ open.

Behind the machine tool 100 is a plasma power pack 102 for operating the plasma torch 20. A dust collector 103 collects smoke and dust from operation of the plasma torch 20. To the immediate rear of the frame 13 is a hydraulic power unit 104 for powering the operation of features of machine tool 100.

Worktable 24 located to the right of frame 13, FIG. 9 is a worktable 24 like that of FIGS. 1-4.

To the left of the machine tool 100 is a loader/unloader 101 that has a magnetic platen 105 that has a Programmable Logic Controller, PLC 106. The CNC of machine tool 100 communicates to PLC 106 which of the magnets 107 are to be utilized and what magnetic field strength to employ. PLC 106 activates and deactivates the selected magnets and monitors their operation.

To the left of the workclamp 6 is a bracket 108 attached to the stationary X-axis rail 8′. A photo switch 109 is mounted to the bracket 108. The photo switch 109 is preferably the same type as a Cutler Hammer E58-30DP150-ELPB. Other similar photo switches may also be used. The function of the photo switch 109 is to find the left edge of a workpiece that has been loaded into the workclamps 6 and 6′. The description of how this is accomplished will follow later. The CNC has a “fixture offset” position associated with the position of the photo switch 109. The CNC also has a “modifier” position associated with the position of the photo switch 109 such that the photo switch does not have to be installed exactly at the “fixture offset” position. The CNC adds the positive or negative “modifier” to the “fixture offset” position to determine exactly where the photo switch is installed relative to the X-axis “0”.

A smart drive, not shown, such as a VLT 5000 series voltage vector control drive manufactured by Danfoss, that is programmed in statement language, positions the Z-axis of the loader/unloader 101 by operating a motor that cannot be seen. Other similar drives may also be used. The motor and associated components are named the Z-Axis because they raise and lower magnetic platen 105. The smart drive closes the motor position loop accomplishing control of the axis independently from the CNC.

The pivoting motion of the loader/unloader 101, driven by a servomotor 110, is named the W-axis. Preferably, the pivoting motion is controlled directly by the CNC of machine tool 100. This control scheme is used because of availability within the CNC system of a control function allowing a commanded move to be terminated before reaching the commanded position and for the remainder of the move to be abandoned or skipped.

To the left rear of the machine tool 100 is a material storage tower 111 for storage of various thickness of raw material to be processed. Material storage tower 111 has a loading side 112 and a material staging station 113. The loading side 112 is equipped with an elevator apparatus to store and retrieve pallets of material from the storage tower. The material staging station 113 contains magnetic sheet fanners to assist separation of steel sheets. A pallet of material 3 is removed from the storage tower 111 by the elevator apparatus then moved by a pallet transfer apparatus to the material staging station 113 for loading by the loader/unloader 101 to worktable 4, into workclamps 6 and 6′, against registration surfaces 5 and 5′, for processing by machine tool 100.

In its preferred form, the material storage tower 111 is controlled by a standalone PLC. Preferably, a smart drive, such as a VLT 5000 series voltage vector control drive manufactured by Danfoss, controls the elevator drive. Other similar drives may be used. Such a smart drive closes the motor position loop accomplishing control of the axis independently from the PLC. The PLC communicates with the smart drive. These communications request the elevator drive to position the material tower elevator to specified shelf locations. The material storage tower PLC controls the movement of pallets in and out of the shelves of the tower. The pallet transfer apparatus, which moves a pallet from the material tower elevator to the material staging position 113, is also controlled by the PLC. The CNC of the machine tool 100 communicates with the material storage tower PLC requesting a specific action such as delivery of 0.5-inch thick material to the material staging position 113. The PLC initiates the action and signals the CNC when that action has been accomplished.

In alternate form, the CNC of the machine tool 100 controls the material storage tower 111 in place of the standalone PLC. In this embodiment the elevator drive for the material storage tower 111 remains a smart drive programmed in statement language. The CNC communicates with the smart drive. These communications cause the elevator drive to position the material tower elevator to a requested shelf. The CNC controls movement of pallets in and out of the shelves of the storage tower 111. The pallet transfer apparatus, which moves a pallet from the material storage tower elevator to the material staging position 113 for loading, is also controlled by the CNC via input/output logic.

After a pallet is positioned at the material staging position 113 the CNC communicates with the PLC 106 of the magnetic platen 105. This communication informs PLC 106 which magnets to activate and what magnetic field strength to develop to ensure a single sheet of material is picked up. Once this transmission has been completed, the CNC initiates a load cycle. Following is a description of an example of that cycle.

(1) The Z-axis of the loader/unloader 101 moves to a full up position such that magnets 107 will clear the top of X rail 8′.

(2) The following dimensions, formulas, and parameters are given by example and not by limitation. The X-axis moves the workclamps 6 and 6′ to a calculated plate load position ((((“X”−1)*10.236)+7.244)+28.0) where “X” contains the tool pocket number of the second workclamp, 10.236 is the distance between tool pockets, 7.244 is the distance from the centerline of the first tool pocket to the centerline of the machine tool 100, and 28.0 is an approximate minimum position required to assure the second workclamp, workclamp 6′, is in a position to clamp the workpiece 3′. The 28.0 position can be changed to suit installation conditions. Simultaneously, the Y-axis moves the workhead 14 and the plasma torch 20 to a safe location out of the way of the loading cycle. Simultaneously, the W axis moves over the material staging position 113 and all the magnets 107 are fully de-energized to have no attraction to metal.

(3) The workclamps 6 and 6′ reach load position, then open.

(4) The W-axis of the loader/unloader 101 reaches the staging position, and then the Z-axis of the loader/unloader 101 moves down until material 3 is contacted, then stops. A sensor apparatus 116 associated with the magnetic platen 105 indicates to the CNC “contact with material”.

(5) Upon receipt of the “contact with material” signal, the CNC commands the PLC 106 to prepare to pick up a sheet of material. All other signals to the PLC 106 are off. The PLC 106 activates all previously selected magnets at specified magnetic field strength, and all other magnets to the off (fully deactivated magnetic field strength level). When the PLC 106 verifies that all magnets 107 are properly seated and energized to specified magnetic field strength, PLC 106 communicates an “ok to go” signal to the CNC.

(6) Upon receipt of the “ok to go” signal, the CNC commands the smart drive of loader/unloader 101 to move the Z-axis up. At a pre-designated time, when the magnetic platen 105 is far enough away from the top of the material stack that switching all magnets to high power will not cause the magnetic platen 105 to pick up another sheet of material, the CNC commands PLC 106 to energize all magnets to fall magnetic field strength. Tentatively, the time is set to three seconds after the start of the up move. If the Z-axis reaches full up position before the magnets have been energized to full field strength, the CNC commands PLC 106 to energize all magnets to full magnetic field strength at full up position.

(7) With the magnetic platen 105 at full up position, sensor apparatus 116 communicating that the sheet of material is held by the magnetic platen 105, and PLC 106 communicating that all magnets are at full field strength, the CNC moves the loader W-axis to a position over the worktable 4 such that the rear edge of the sheet is forward of the workclamps 6 and 6′ then stops.

(8) The CNC commands the smart drive of the loader 101 Z-axis to lower the magnetic platen 105. Z-axis motion stops when the sensor apparatus 116 indicates the material has reached the surface of the worktable 4 or when the distance to the worktable 4 has been traveled.

(9) The CNC releases locking apparatus 114 of loader 100 to allow the sheet of material to align with workclamps 6 and 6′ against the sensors 5 and 5′ and moves the loader/unloader 101 W-axis toward the open workclamps 6 and 6′.

(10) When the sensors 5 and 5′ detect the sheet of material is against the registration surfaces of workclamps 6 and 6′, W-axis motion is halted and the workclamps are closed.

(11) When the workclamps 6 and 6′ have closed the CNC commands PLC 106 to de-energize all magnets 107 to zero magnetic field strength to release the plate.

(12) The PLC 106 communicates to the CNC that all the magnets 107 are at zero magnetic field strength then the CNC commands the smart drive of the loader/unloader 101 to move the Z-axis to the full up position. This full up position, above the worktable 4 is the standby position of the loader/unloader 101.

(13) The smart drive controlling the loader/unloader 101 Z-axis signals the CNC that the Z-axis is at the full up position, then the CNC commands the PLC 106 to energize all the magnets 107 to full strength to conserve power and the CNC initiates finding the leading edge of the workpiece 3′ loaded in the workclamps 6 and 6′.

(14) The CNC moves an X-axis table 11 carrying the workclamps 6 and 6′ and the workpiece 3′ in a series of incremental moves such that the position of the left edge of the workpiece 3′ relative to X “0” is accurately determined by a photo sensor 109. If the photo sensor 109 detects the workpiece 3′, the first of the series of moves is to the right, X minus, until the photo sensor 109 loses the workpiece 3′. If the photo sensor 109 does not detect the workpiece 3′, the first of the series of moves is to the left, X plus, until the photo sensor 109 detects the workpiece 3′. The CNC then reverses the direction of travel of the X-axis table 11, reduces the move velocity and reduces the move increment to a smaller step such that the photo sensor 109 changes state. This process is repeated several times with direction changes and smaller increment steps until the location of the edge of the workpiece 3′ in the X-axis is accurately determined.

(15) The CNC then calculates the position of the edge of the workpiece 3′ relative to the X-axis zero position. The CNC uses this calculated position to reposition the workclamps 6 and 6′ relative to the workpiece 3′.

(16) The CNC moves the X and Y-axes to a position such that the reposition cylinders 19 can clamp the workpiece 3′ during repositioning of the workclamps 6 and 6′.

(17) The CNC initiates the reposition cylinders 19 to clamp the workpiece 3′.

(18) The CNC initiates opening workclamps 6 and 6′ thereby releasing the workpiece 3′.

(19) The CNC moves the X-axis table 11 to reposition the workclamps 6 and 6′ such that when the workclamps 6 and 6′ are closed and the X-axis table 11 is moved to X “0”, the left edge of the workpiece 3′ will be positioned on the X centerline of the workhead 14.

(20) The CNC initiates closure of the workclamps 6 and 6′ to grip the workpiece 3′.

(21) The CNC initiates the reposition cylinders 19 to retract to their full up position.

(22) The workpiece 3′ is now fully gauged and ready for processing by the machine tool 100.

The machine tool 100 processes the workpiece 3′ such that all punching operations are performed; then any larger holes are cut with the plasma torch. Afterward, the plasma torch cuts individual parts from the workpiece 3′. Small parts are unloaded from the machine via a drop leaf table 21. Parts too large for the drop leaf table 21 are unloaded by loader/unloader 101.

An unloading zone 115, FIG. 9 outlines an area for unloading large parts. The unloading function of the loader/unloader 101 can stack parts on a table or on pallets or drop parts into containers located within the unloading zone 115.

When a part too large for the drop leaf table 21 is cut out by plasma torch, the CNC moves the W-axis of the loader/unloader 101 to position the magnetic platen 105 over the worktable 4 such that the magnets 107 are over the large part to be removed, then stops. The CNC commands the PLC 106 to reduce the magnetic field of all magnets to “0”. When the PLC 106 signals the CNC that all the magnets 107 are at “0” magnetic field strength, the CNC commands the smart drive of the loader/unloader 101 to move the Z-axis down until the sensor apparatus 116 indicates to the CNC that the workpiece 3′ has been contacted. The CNC instructs the PLC 106 which of the magnets 107 to energize and what magnetic field strength to employ. The PLC 106 energizes the specified magnets then sends an “ok to go” signal to the CNC. Upon receipt of the “ok to go” signal, the CNC commands the smart drive of loader/unloader 101 to move the Z-axis up. At a pre-designated time, when the magnetic platen 105 has been raised above the workpiece 3′ and if the magnetic fields are not already at full strength, the CNC commands the PLC 106 to energize the previously selected magnets to full magnetic field strength. Tentatively, the time is set to two seconds after the start of the up move. If the Z-axis reaches full up position before the magnets have been energized to full field strength, the CNC commands the PLC 106 to energize the previously selected magnets to full magnetic field strength at full up position. With the magnetic platen 105 at full up position, the sensor apparatus 116 communicating that the part is held by the platen, and the PLC 106 communicating that the selected magnets are at full field strength, the CNC moves the loader W-axis to a commanded position over the unloading zone 115 then stops. When the part has been moved horizontally clear of the worktable 4, the CNC restarts processing the part program controlling machine tool 100. The CNC will either drop the part into a container or stack the part on a table or a pallet.

If the command is to drop the part, the CNC commands the PLC 106 to reduce the magnetic field strength of the selected magnets 107 to “0”. When the CNC receives a signal from the PLC 106 that the magnetic field strength is at “0” and receives confirmation from the sensor apparatus 116 that the magnets 107 no longer hold the part, the CNC commands the PLC 106 to energize all the magnets 107 to full strength, to conserve power, and moves the loader W-axis back to the standby position over the worktable 4.

If the command is to stack the part, the CNC commands the smart drive of the loader/unloader 101 Z-axis to lower the magnetic platen 105. Z-axis motion stops when the sensor apparatus 116 indicates the workpiece 3′ has reached the surface of the pallet, table, or stack. Upon receipt of the contact signal, the CNC commands platen the PLC 106 to reduce the magnetic field strength of the selected magnets to “0”. When the CNC receives a signal from the PLC 106 that the magnetic field strength of all the magnets 107 is at “0”, the CNC commands the smart drive of the loader/unloader 101 Z-axis to move to the full up position. The smart drive of loader/unloader 101 Z-axis signals the CNC that the Z-axis is at the full up position then the CNC commands the PLC 106 to energize all the magnets 107 to full magnetic field strength to conserve power and moves the loader/unloader 101 W-axis back to the standby position over the worktable 4.

It can now be seen by one of ordinary skill in the art that the present invention provides a new and improved means to remove skeletal remnants from a plasma torch or laser equipped CNC punch press. The apparatus requires no extra space at the machine tool for storage of the removed skeletal remnants. No dedicated transfer device for the skeletal remnants is utilized, reducing manufacturing cost. In a preferred form, the scrap table 24 is adapted with conveyor rollers and functions to support the workpiece 3′ during operation of the machine tool 1 and to unload and stack a skeletal remnant. In alternate form the scrap table 124 can be adapted with ball transfer bearings such that it can reside proximate an automatic sheet loader and can support a workpiece during a load cycle, support the workpiece during operation of the machine tool 100 and unload and stack a skeletal remnant. In other alternate forms, the scrap tables 24, 124 can be adapted with skate wheel conveyors, barrel rollers, omni-wheels or brushes as best suits the application of the CNC punch press. Further, the scrap table 24 can be adapted with a pallet for stacking skeletal remnants on or a conveyor means for transporting skeletal remnants elsewhere for disposal or storage.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A worktable apparatus associated with a machine tool that fabricates at least one part from a workpiece, comprising in combination:
a frame supporting a drop leaf table apparatus adapted with means for translatably supporting a workpiece, said worktable apparatus supporting the workpiece during processing by said machine tool;
said drop leaf table apparatus adapted to pivot between a substantially horizontal supporting position and a substantially vertical unloading position such that unloaded material processed by said machine tool falls substantially vertically through said frame.

2. The combination of claim 1, further comprising: said worktable apparatus is adapted with a cantilevered extension that is adapted with means for translatably supporting a workpiece.

3. The combination of claim 1 wherein said support means is a plurality of conveyor rollers.

4. The combination of claim 1 wherein said support means is a plurality ball transfer bearings.

5. The combination of claim 1 wherein the unloaded material is stacked on blocks residing proximate the floor.

6. The combination of claim 1 wherein the unloaded material is stacked on a pallet residing proximate the floor.

7. The combination of claim 1 wherein the unloaded material falls on a conveyor.

8. The combination of claim 1 wherein said worktable apparatus resides on a side opposite of said machine tool loading side.

9. The combination of claim 1 wherein said worktable apparatus resides on the loading side of said machine tool.

10. The combination of claim 1 wherein said machine tool is a CNC punch press having an automatic tool changer apparatus.

11. The combination of claim 1 wherein said machine tool is a CNC punch press having an automatic tool changer apparatus and a thermal cutting apparatus.

12. The combination of claim 11 wherein said thermal cutting apparatus is a plasma torch apparatus.

13. The combination of claim 11 wherein said thermal cutting apparatus is a laser cutting apparatus.

14. The combination of claim 1 wherein said machine tool is a plasma cutting machine tool.

15. The combination of claim 1 wherein said machine tool is a laser cutting machine tool.

16. A worktable apparatus associated with a machine tool that fabricates at least one part from a workpiece, said worktable apparatus adapted to unload material processed by said machine tool and comprising in combination;
a frame adapted with a drop leaf table apparatus and such that unloaded material falls substantially vertically through said frame, said worktable apparatus supporting the workpiece during processing by said machine tool; and
said drop leaf table apparatus comprising at least two drop leaf tables adapted for engagement by at least one driving apparatus, each said drop leaf table having a means for translatably supporting a workpiece, each said drop leaf table capable of pivoting between a substantially horizontal supporting position and a substantially vertical unloading position.

17. The combination of claim 17 wherein said driving apparatus is a cylinder.

18. A worktable apparatus residing on a side opposite of a loading side of a CNC machine tool that fabricates at least one part from a workpiece comprising in combination;
a frame adapted with a drop leaf table apparatus, said drop leaf table apparatus supporting the workpiece during processing by said machine tool, unloaded material processed by said CNC machine tool falling substantially vertically through said frame, the unloaded material being removed from within a boundary of said frame through at least one side of said frame;
said frame adapted with a cantilevered extension adapted with workpiece supporting means;
said drop leaf table apparatus adapted with workpiece supporting means, said drop leaf table apparatus including at least two drop leaf tables adapted with a driving apparatus so as to pivot between a substantially horizontal supporting position and a substantially vertical unloading position, said driving apparatus being at least one cylinder pivotably connected to said frame and pivotably connected to each said drop leaf table;
one of said drop leaf tables associated with workclamps that move and position said workpiece; and
said worktable apparatus controlled by the CNC of said CNC machine tool.

19. The combination of claim 18 wherein said workpiece supporting means is a plurality of conveyor rollers.

20. The combination of claim 18 wherein said workpiece supporting means is a plurality of ball transfers.

21. A worktable apparatus residing on a loading side of a CNC machine tool that fabricates at least one part from a workpiece, comprising in combination;
a frame adapted with a drop leaf table apparatus, said drop leaf table apparatus supporting the workpiece during processing by said CNC machine tool, unloaded material falling substantially vertically through said frame, said unloaded material being removed from within a boundary of said frame through at least one side of said frame;
said frame adapted with a cantilevered extension adapted with workpiece supporting means;
said drop leaf table apparatus adapted with workpiece supporting means, said drop leaf table including at least two drop leaf tables adapted with a driving apparatus so as to pivot between a substantially horizontal supporting position and a substantially vertical unloading position;
said driving apparatus being at least one cylinder pivotably connected to said frame and pivotably connected to each said drop leaf table;
one of said drop leaf tables associated with workclamps that move and position the workpiece;
said worktable apparatus controlled by the CNC of said CNC machine tool.

22. The combination of claim 21 wherein said workpiece supporting means is a plurality of conveyor rollers.

23. The combination of claim 21 wherein said workpiece supporting means is a plurality of ball transfers.

24. The combination of claim 21 wherein said CNC machine tool is associated with an automatic loading apparatus.

25. The combination of claim 21 wherein said machine tool is associated with an automatic loading apparatus and a material storage tower.
